(19) United States
(12) Patent Application Publication
(10) Pub. No.: US 2011/0264363 A1
(43) Pub. Date: Oct. 27, 2011

(54) Method of Estimating Travel Time on a Route

(75) Inventor: Cesar Cabral, Los Angeles, CA (US)

(73) Assignee: Honda Motor Co., Ltd., Minato-ku (JP)

(21) Appl. No.: 12/768,323

(22) Filed: Apr. 27, 2010

(51) Int. Cl. G01C 21/34; G08G 1/00

(52) U.S. Cl. 701/200

(57) ABSTRACT

A method of estimating travel times for a route for purposes of navigating a motor vehicle is disclosed. The method includes steps of retrieving traffic information for roadways including traffic information. The method also includes steps of calculating congestion factors for roadways not having traffic information according to their proximity to roadways having traffic information. In some embodiments, a map portion is divided into meshes and a congestion factor is calculated for each mesh according to the proximity of the mesh from meshes with roadways including traffic information.

### BACKGROUND

The present invention relates generally to a motor vehicle, and in particular to a method of estimating travel time on a route provided by a navigation system.

Navigation systems in motor vehicles typically calculate an initial route of travel between a starting location and a destination. Navigation systems may make use of various kinds of information to determine an accurate travel time for a route. Some systems use real time traffic information to estimate delays in the travel time due to traffic congestion.

The related art lacks provisions for more accurately estimated travel times on routes including roadways lacking traffic information.

### SUMMARY

In one aspect, the invention provides a method of providing navigation information for a motor vehicle, comprising the steps of: retrieving navigation information; selecting a first roadway segment and a second roadway segment from the navigation information, the second roadway segment being within a predetermined distance from the first roadway segment; retrieving traffic information corresponding to the second roadway segment; calculating a congestion factor for the first roadway segment using the traffic information corresponding to the second roadway segment; and using the congestion factor to estimate a travel time for a route, the route including the first roadway segment.

In another aspect, the invention provides a method of providing navigation information for a motor vehicle, comprising the steps of: retrieving navigation information corresponding to a portion of a map; dividing the portion of the map into a plurality of meshes; selecting an absorbing mesh from the plurality of meshes; retrieving a predetermined distance; selecting a set of meshes, the set of meshes being within the predetermined distance from the absorbing mesh and wherein each mesh in the set of meshes includes at least one roadway segment with traffic information; calculating a congestion factor for the absorbing mesh using traffic information from each mesh in the set of meshes; and using the congestion factor to calculate a travel time for a route, the route including a roadway segment in the first mesh.

In another aspect, the invention provides a method of providing navigation information for a motor vehicle, comprising the steps of: retrieving navigation information corresponding to a plurality of roadway segments; retrieving traffic information for a first set of roadways; selecting a second set of roadways; estimating congestion information for the second set of roadways using the traffic information; and using the estimated congestion information to calculate the travel time along a route.

Other systems, methods, features and advantages of the invention will be, or will become, apparent to one of ordinary skill in the art upon examination of the following figures and detailed description. It is intended that all such additional systems, methods, features and advantages be included within this description and this summary, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic view of an embodiment of a navigation system associated with a motor vehicle;

FIG. 2 is an embodiment of a process for operating a navigation system;

FIG. 3 is view of an embodiment of an interior portion of a passenger cabin of a motor vehicle;

FIG. 4 is an embodiment of a process for estimating a travel time on a route;

FIG. 5 is a schematic view of an embodiment of a map portion associated with a navigation system;

FIG. 6 is an embodiment of a process of estimating congestion information on various roadways;

FIG. 7 is a schematic view of an embodiment of a map portion divided into a plurality of meshes;

FIG. 8 is a schematic view of an embodiment of a map portion in which each mesh is associated with a congestion factor;

FIG. 9 is an embodiment of a process of estimating the travel time on a route;

FIG. 10 is an embodiment of a process of calculating a congestion factor;

FIG. 11 is schematic view of an embodiment of a map portion used to illustrate a method of calculating a congestion factor for a mesh; and

FIG. 12 is an embodiment of a process of calculating a congestion factor.

### DETAILED DESCRIPTION

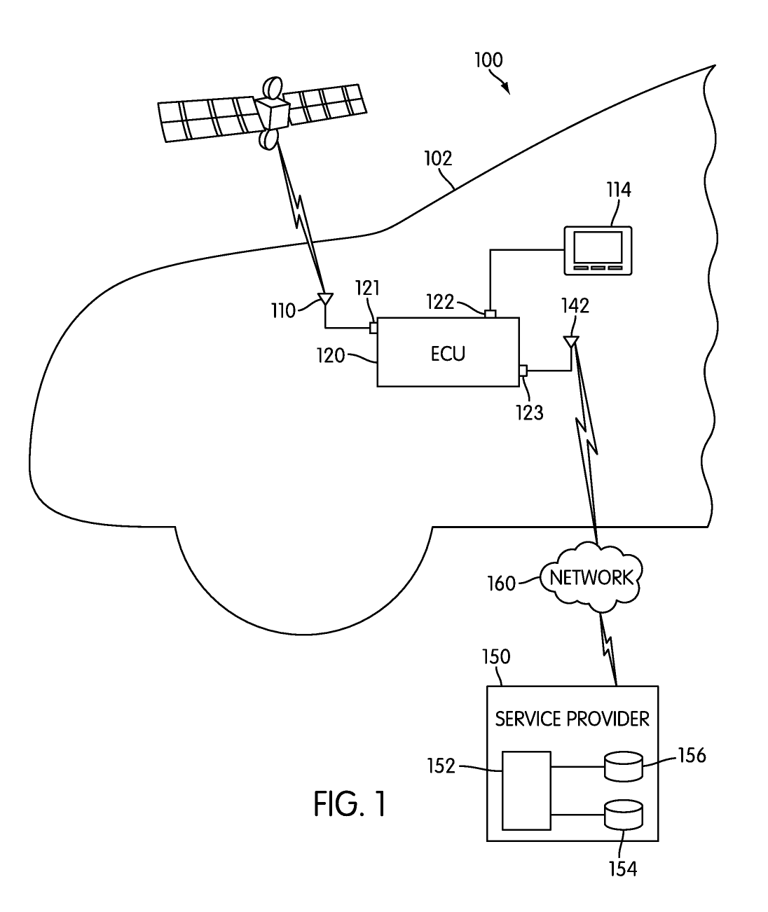

FIG. 1 is a schematic view of an embodiment of navigation system 100 that is configured to be used with motor vehicle 102. For purposes of clarity, only some components of a motor vehicle that may be relevant to navigation system 100 are illustrated. Furthermore, in other embodiments, additional components can be added or removed.

Navigation system 100 can be any system capable of providing navigation information to a user. The term “navigation information” refers to any information that can be used to assist in determining a location or providing directions to a location. Some examples of navigation information include street addresses, street names, street or address numbers, apartment or suite numbers, intersection information, points of interest, parks, any political or geographical subdivision including town, township, province, prefecture, city, state, district, ZIP or postal code, and country. Navigation information can also include commercial information including business and restaurant names, commercial districts, shopping centers, and parking facilities. Navigation information can also include geographical information, including information obtained from any Global Navigational Satellite System (GNSS), including Global Positioning System or Satellite (GPS), Glonass (Russian) and/or Galileo (European). The term “GPS” is used to denote any global navigational satellite system. Navigation information can include one item of information, as well as a combination of several items of information.

Generally, any navigation system known in the art can be used. One example of a navigation system is disclosed in U.S. Patent Application Publication Number 2005/0261827, to Furukawa, and filed on May 19, 2004, the entirety of which is hereby incorporated by reference. Another example of a navigation system is disclosed in U.S. Pat. No. 5,842,146, to Shishido, and filed on May 10, 1996, the entirety of which is hereby incorporated by reference.

Navigation system 100 can include provisions for receiving GPS information. In some cases, navigation system 100 can include GPS receiver 110. For purposes of clarity, GPS receiver 110 is illustrated in the form of a GPS antenna in the current embodiment. However, it will be understood that GPS receiver 110 can be associated with both an antenna and a separate receiving device in some embodiments. In an exemplary embodiment, GPS receiver 110 can be used for gathering a current location for motor vehicle 102. With this arrangement, navigation system 100 may be configured to automatically determine a beginning point for a particular route as well as for tracking the position of motor vehicle 102 along the route.

Navigation system 100 can include provisions for communicating with a driver. In some embodiments, navigation system 100 can include interface 114. In some cases, interface 114 can include provisions for transmitting information to a driver and/or passenger. For example, interface 114 can include a display screen that displays maps including vehicle location and route information. In other cases, interface 114 can include provisions for receiving information from a driver and/or passenger. For example, interface 114 can include buttons that allow a driver to input destinations for determining routes. In some cases, the buttons may be push-type buttons disposed adjacent to a display screen. In other cases, the display screen can be a touch-screen display capable of receiving user input. In an exemplary embodiment, interface 114 can include provisions for transmitting and receiving information from a driver and/or passenger.

Motor vehicle 102 may include provisions for communicating with, and in some cases controlling, the various components associated with navigation system 100. In some embodiments, navigation system 100 may be associated with a computer or similar device. In the current embodiment, navigation system 100 may include electronic control unit 120, hereby referred to as ECU 120. In one embodiment, ECU 120 may be configured to communicate with, and/or control, various components of navigation system 100. In addition, in some embodiments, ECU 120 may be configured to control additional components of a motor vehicle that are not shown.

ECU 120 may include a number of ports that facilitate the input and output of information and power. The term “port” as used throughout this detailed description and in the claims refers to any interface or shared boundary between two conductors. In some cases, ports can facilitate the insertion and removal of conductors. Examples of these types of ports include mechanical connectors. In other cases, ports are interfaces that generally do not provide easy insertion or removal. Examples of these types of ports include soldering or electron traces on circuit boards.

All of the following ports and provisions associated with ECU 120 are optional. Some embodiments may include a given port or provision, while others may exclude it. The following description discloses many of the possible ports and provisions that can be used, however, it should be kept in mind that not every port or provision must be used or included in a given embodiment.

In some embodiments, ECU 120 can include first port 121 for communicating with GPS receiver 110. In particular, ECU 120 may be configured to receive GPS information from GPS receiver 110. Also, ECU 120 can include second port 122 for communicating with interface 114. In particular, ECU 120 can be configured to transmit information to interface 114, as well as to receive information from interface 114.

In some embodiments, a navigation system can be associated with service provider 150. The term “service provider” as used throughout this detailed description and in the claims refers to any collection of computing resources and/or databases that are disposed outside of motor vehicle 102 and which are capable of providing resources to motor vehicle 102. In some cases, service provider 150 may be a collection of networked computers or computer servers. Service provider 150 may be used to receive, process and/or store information of any kind. In one embodiment, service provider 150 may be configured to collect information related to traffic on roadways, process the information and store the information for later use. In addition, service provider 150 may be configured to calculate routes for navigation system 100.

Service provider 150 may include computer system 152. The term “computer system” refers to the computing resources of a single computer, a portion of the computing resources of a single computer, and/or two or more computers in communication with one another, also any of these resources can be operated by one or more human users. In one embodiment, computer system 152 includes a server.

A service provider can include various provisions for storing information. In embodiments where a service provider may be used to calculate routes for a navigation system, the service provider can include one or more databases for storing information. In some embodiments, a service provider can include one or more databases for navigation information. In addition, in some embodiments, a service provider can include one or more databases for storing traffic information. In other embodiments, where routes may be calculated onboard of a motor vehicle by an electronic control unit or another system, the motor vehicle can include one or more databases that store traffic information. It will be understood that various different databases could also provide other types of information including, but not limited to: weather information, carpool lane information, energy consumption information as well as any other kind of information.

In this embodiment, service provider 150 may be provided with map database 154, which stores navigation information. Service provider 150 may also be provided with traffic database 156. Traffic database 156 may be any kind of database configured to store traffic information. The term “traffic information” as used throughout this detailed description and in the claims refers to any information related to the speed of one or more vehicles on a roadway. Traffic information can include the current speeds of one or more vehicles. In some cases, the average speed of vehicles on a roadway may be stored as traffic information. Traffic information may refer to either real-time traffic information or historic traffic information.

Map database 154 and traffic database 156 can communicate with computer system 152. Map database 154 and traffic database 156 can include any kind of storage device, including but not limited to: magnetic, optical, magneto-optical, and/or memory, including volatile memory and non-volatile memory. In some embodiments, map database 154 and traffic database 156 may be integral with computer system 152. In other embodiments, map database 154 and traffic database 156 may be separate from computer system 152.

A navigation system can include provisions for communicating with a service provider. In one embodiment, navigation system 100 may communicate with service provider 150 using network 160. Generally, network 160 may be any type of network. In some cases, network 160 may be a vehicle communication network that uses motor vehicles for at least some nodes of the network. In addition, a vehicle communication network may include roadside units as nodes. Vehicle communication networks may be used for exchanging various types of information between motor vehicles and/or roadside units. An example of such a vehicular network is a dedicated short range communication (DSRC) network. In some cases, DSRC networks may be configured to operate in the 5.9 GHz band with bandwidth of approximately 75 MHz. Furthermore, DSRC networks may have a range of approximately 1000 m. In other embodiments, navigation system 100 can be configured to communicate with service provider 150 using any other type of wireless network, including, but not limited to: WiFi networks, cell phone networks, as well as any other type of network. Furthermore, network 160 may be associated with any type of network standard including, but not limited to: CDMA, TDMA, GSM, AMPS, PCS, analog and/or W-CDMA.

In some embodiments, ECU 120 may include third port 123 that is configured to communicate with a network antenna. In an exemplary embodiment, third port 123 may be associated with network antenna 142 that is configured to exchange information with service provider 150 using network 160.

Navigation system 100 can include provisions for communicating with one or more components of a motor vehicle that are not associated directly with navigation system 100. In some cases, ECU 120 may include additional ports for communicating directly with one or more additional devices of a motor vehicle, including various sensors or systems of the motor vehicle.

In some embodiments, all or most of the items shown in FIG. 1 are housed in a single case or unit. In other embodiments, the various items shown in FIG. 1 are not housed in a single physical case, but instead, are distributed throughout motor vehicle 100 (see FIG. 1) and communicate with one another via known wired or wireless methods. For example, in a system where one or more items communicate wirelessly, the Bluetooth® protocol can be used.

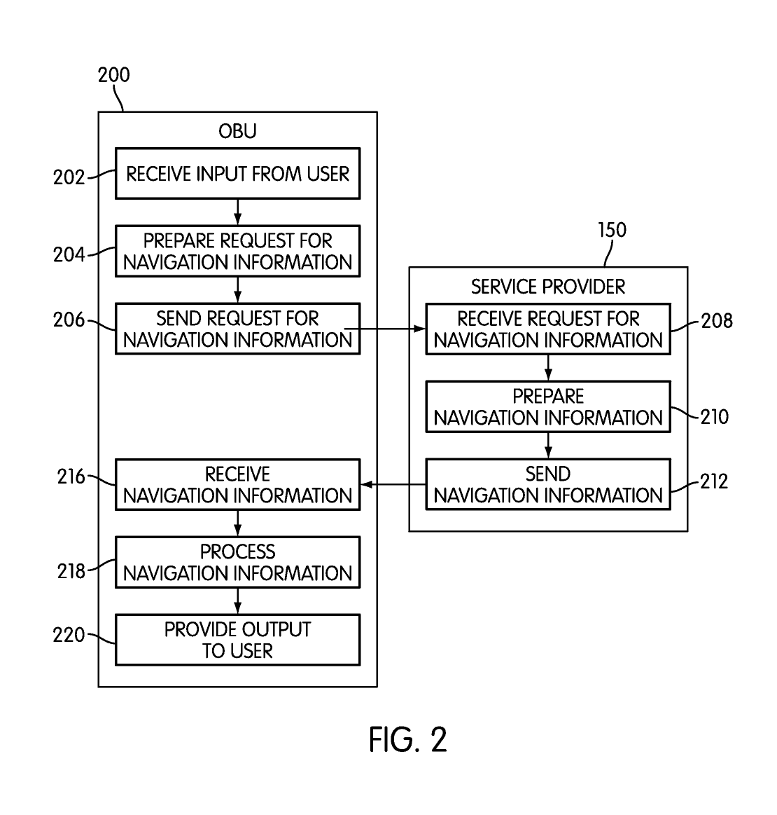

Some embodiments provide a system and method of managing navigation information. FIG. 2 illustrates a process of an embodiment of a system and method for operating navigation information.

In the embodiment shown in FIG. 2, certain steps are associated with On-Board Unit (referred to as “OBU”) 200 and certain steps are associated with service provider 150. In some cases, those steps associated with OBU 200 are performed on or by OBU 200 and those steps associated with service provider 150 are performed on or by service provider 150. However, this is not necessarily the case, and those steps associated with OBU 200 can be performed on or by service provider 150 or some other resource, and those steps associated with service provider 150 can be performed on or by OBU 200 or some other resource.

OBU 200 is a device or provision associated with motor vehicle 102. In some embodiments, OBU 200 includes provisions that permit OBU 200 to receive information. In some embodiments, OBU 200 can store information in a memory or computer readable media. In some embodiments, OBU 200 includes provisions that permit OBU 200 to process information. In some embodiments, OBU 200 includes provisions that permit OBU 200 to display information. In some embodiments, OBU 200 includes provisions that permit OBU 200 to receive information from a user. In some embodiments, OBU 200 includes provisions that permit OBU 200 to receive information from a wireless network. In some embodiments, OBU 200 includes provisions that permit OBU 200 to interact with a user. In some embodiments, OBU 200 includes a combination of two or more of the above provisions.

Different embodiments can include different elements or features. For simplicity, the term, “On-Board Unit” (OBU) is used to refer to those elements or components that are associated with motor vehicle 100 (see FIG. 1) for a particular embodiment. In an exemplary embodiment, OBU 200 comprises one or more facilities of ECU 120. OBU can also include one or more of the items shown in FIG. 1, for example, ECU 120, interface 114, and/or GPS receiver 110.

In some embodiments, as shown in FIG. 2, the process begins when an input is received in step 202. Any form of input can be received in step 202. In some cases, the input is in the form of one or more buttons being pressed, and/or interaction with a touch screen associated with interface 114. In some cases, a combination of input from buttons and/or touch screen interaction is received. As an example, in one embodiment a user may input a desired destination using interface 114. In some cases, a user could also input a starting location. In other cases, however, the current location as determined from information received at GPS receiver 110 can be used as the starting location.

It is also possible for voice information to be received in step 202. Any known speech recognition process or program can be utilized to convert spoken words, phrases and/or numbers into a machine readable format. Preferably, the IBM® embedded Via Voice speech recognition engine is used.

In step 204, OBU 200 analyzes and processes the information received in step 202 and prepares a request for navigation information. In step 206, OBU 200 sends a request for navigation information. In step 208, service provider 150 receives a request for navigation information. In step 210, service provider 150 analyzes and processes the request for navigation information and prepares a response to the request. In step 212, service provider 150 sends the requested navigation information to OBU 200.

During step 216, OBU 200 receives the navigation information. Following this, during step 218 and step 220, OBU processes the navigation information and then provides the output to a user. In some cases, for example, the navigation information includes a navigation route between a current location and a destination. The navigation information may be displayed visually on interface 114 for a user.

It will be understood that in other embodiments, the steps performed by service provider 150 may be accomplished by OBU 200. In particular, in some cases, OBU 200 may be configured to prepare navigation information including routes between various geographic locations. In these embodiments, OBU 200 may also communicate with one or more remote databases that can store traffic information, weather information as well as any other kinds of information that may be used to determine a route for a motor vehicle.

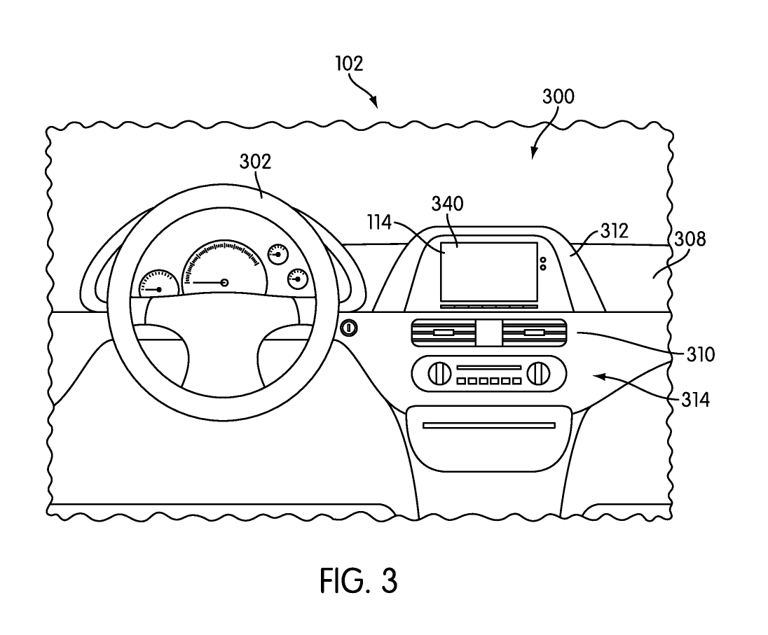

FIG. 3 is an exemplary embodiment of an interior 300 of a passenger cabin in motor vehicle 102 (see FIG. 1). Interior 300 includes steering wheel 302, dashboard 308 and center console 310. Center console 310 includes an upper portion 312 and a lower portion 314. In some embodiments, lower portion 314 includes radio and/or audio controls. In one embodiment, upper portion 312 includes interface 114. In some embodiments, upper portion 312 may include a multi-function unit that can communicate or control an audio system, a climate control system and/or a navigation system. In one embodiment, ECU 120 or portions of ECU 120 are disposed behind interface 114. In some embodiments, interface 114 can include display screen 340. In some cases, interface 114 can also include buttons. Furthermore, in some cases, display screen 340 may be a touch screen.

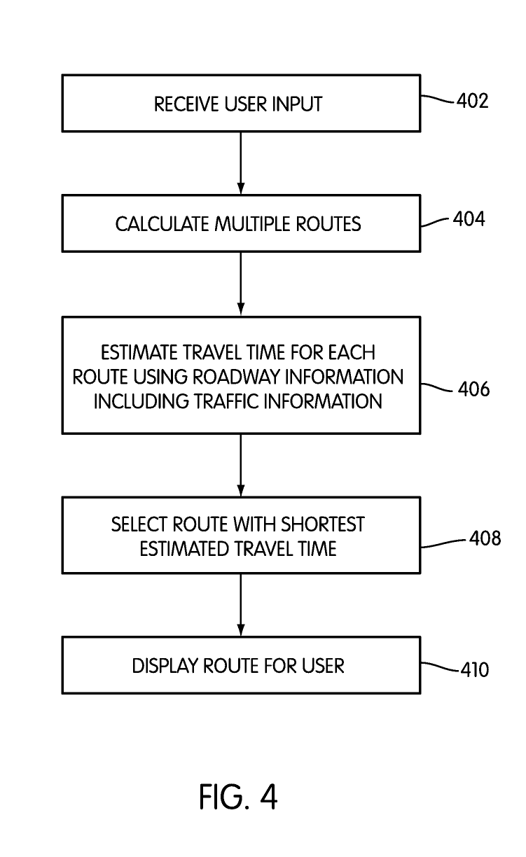

FIG. 4 illustrates an embodiment of a process of operating a navigation system. In some embodiments, some of the following steps could be accomplished by OBU 200. In other embodiments, some of the following steps could be accomplished by service provider 150. In addition, in other embodiments, some of the steps could be performed by other components of motor vehicle 102. For purposes of clarity, navigation system 100 may be used to refer collectively to OBU 200 and/or service provider 150. In other words, steps performed by navigation system 100 may be performed by either OBU 200 or service provider 150 in the following embodiments. It will be understood that in other embodiments one or more of the following steps may be optional.

During step 402, navigation system 100 may receive input from a user. In some cases, this step can be performed by OBU 200. For example, in some cases, a user may input a desired destination into interface 114. In other embodiments, any other type of input could be received during step 402. Next, during step 404, navigation system 100 may calculate multiple routes between a starting location and a destination. During step 406, navigation system 100 may estimate a travel time for each route using roadway information. Roadway information can include, but is not limited to: traffic information, weather information, carpool lane information, energy consumption information, intersection information as well as any other kind of information that may be used for purposes of calculating routes between two geographic locations. In an exemplary embodiment, the roadway information may include traffic information. Using traffic information may allow navigation system 100 to determine a more accurate estimate for the travel time. For example, in situations where one or more roadways along a route are congested, the calculated travel time on that route will be increased accordingly. Next, during step 408, navigation system 100 may select a route with the shortest estimated travel time. Finally, during step 410, the selected route may be displayed for a user.

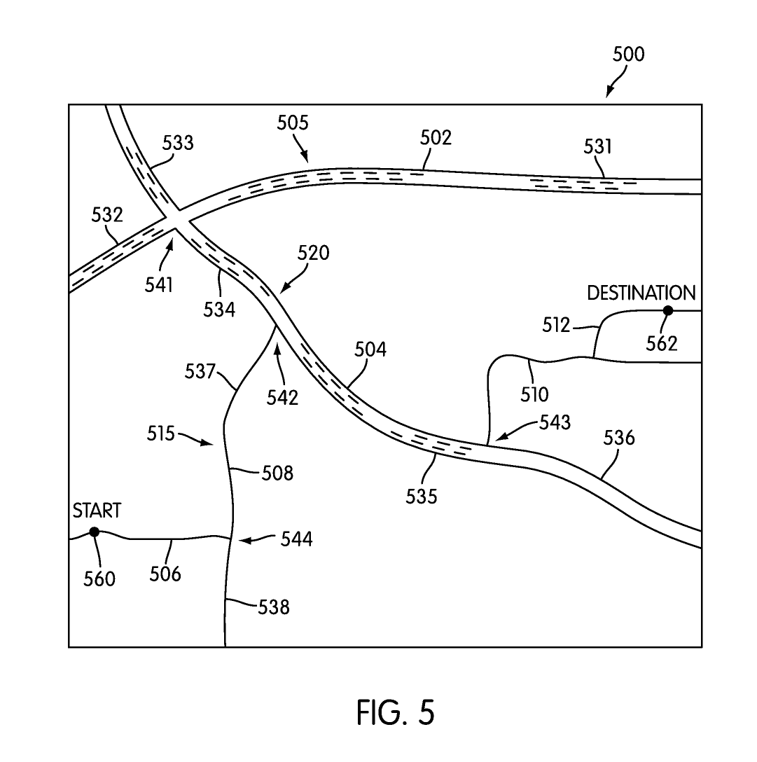

FIG. 5 illustrates an embodiment of various kinds of information that may be stored by navigation system 100. In the current embodiment, navigation information in the form of various types of roadways and other geographic features are displayed as map portion 500. In this case, map portion 500 includes first roadway 502 and second roadway 504. First roadway 502 and second roadway 504 may be major highways. For purposes of convenience, first roadway 502 and second roadway 504 may be referred to as primary roadways 505. In addition, map portion 500 includes third roadway 506, fourth roadway 508, fifth roadway 510 and sixth roadway 512, which may be collectively referred to as secondary roadways 515. In the current embodiment, secondary roadways 515 may be surface streets.

In some embodiments, each roadway may be further divided into various segments or links. The term “roadway segment” as used throughout this detailed description and in the claims refers to any portion of a roadway. In some cases, a roadway segment may extend between two intersections or nodes. For example, in some embodiments, roadways may be stored as a collection of roadway segments that comprise links that are joined together at various intersections. However, in other embodiments, roadway segments may be defined in any other manner.

As an example, in the current embodiment first roadway 502 comprises first roadway segment 531 and second roadway segment 532. First roadway segment 531 and second roadway segment 532 are joined at first intersection 541, which is an intersection between first roadway 502 and second roadway 504. In a similar manner, second roadway 504 comprises third roadway segment 533, fourth roadway segment 534, fifth roadway segment 535 and sixth roadway segment 536 that are connected at first intersection 541, second intersection 542 and third intersection 543. As another example, fourth roadway 508 comprises seventh roadway segment 537 and eighth roadway segment 538 that are connected at fourth intersection 544.

Map portion 500 may be associated with additional roadway information. In some embodiments, map portion 500 can include traffic information. In the current embodiment, primary roadways 505 may be associated with traffic indicators 520 that visually represent areas where traffic information is available.

It will be understood that FIG. 5 is only intended to schematically illustrate navigation information and/or traffic information in the form of a portion of a map. In some cases, navigation information and/or traffic information may be stored in one or more tables. In other cases, navigation information and/or traffic information may be stored in any other form. In other words, navigation information and/or traffic information may not be visually displayed information but may instead only comprise various collections of data stored in one or more databases.

In the current embodiment, a user may want to find the fastest route between starting location 560 and destination 562. In order to estimate the travel time of any route between starting location 560 and destination 562, navigation system 100 may use any available traffic information. As previously discussed, if there is heavy congestion along various roadway segments of a route, navigation system 100 may adjust the estimated travel time. In this case, traffic information is only available on primary roadways 505, which are major roadways or highways. Moreover, a majority of roadways traveled between starting location 560 and destination 562 may comprise secondary roadways 515, which lack traffic information. Without traffic information for secondary roadways 515, navigation system 100 may provide a poor estimate for the travel time on any route between starting location 560 and destination 562.

A navigation system can include provisions for estimating congestion on roadways without traffic information. In some cases, a navigation system can assign a congestion factor to one or more roadways without traffic information according to the proximity of the one or more roadways to roadways having traffic information. For example, in one embodiment, a congestion factor could be assigned to a first roadway segment using information from a second roadway segment including traffic information. As an example, a congestion factor could be calculated for a surface street that is nearby a highway with traffic information. In particular, the congestion factor could be calculated using the level of congestion on the highway and the distance of the surface street from the highway.

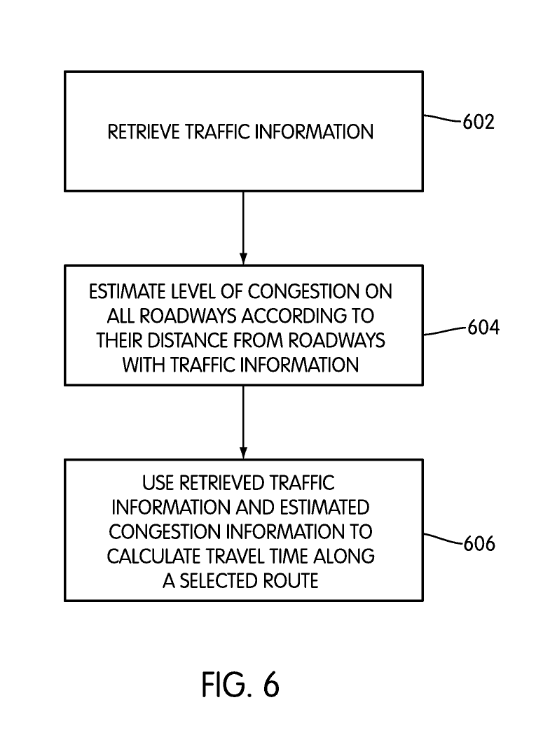

FIG. 6 illustrates an embodiment of a process of operating a navigation system. In some embodiments, some of the following steps could be accomplished by OBU 200. In other embodiments, some of the following steps could be accomplished by service provider 150. In addition, in other embodiments, some of the steps could be performed by other components of motor vehicle 102. For purposes of clarity, navigation system 100 may be used to refer collectively to OBU 200 and/or service provider 150. In other words, steps performed by navigation system 100 may be performed by either OBU 200 or service provider 150 in the following embodiments. It will be understood that in other embodiments one or more of the following steps may be optional.

During step 602, navigation system 100 may retrieve traffic information for roadways where traffic information is available. As discussed above, in some cases, service provider 150 may retrieve traffic information from traffic database 156 (see FIG. 1). In other cases, however, OBU 200 may retrieve traffic information from one or more databases. Moreover, in other embodiments, traffic information can be retrieved in any other manner by an onboard unit or a service provider.

During step 604, navigation system 100 may estimate the level of congestion on all roadways according to their distance from roadways with traffic information. For example, referring back to FIG. 5, it is likely that heavy congestion on second roadway 504 may increase the congestion of fourth roadway 508 and fifth roadway 510, which are directly connected to second roadway 504. Additionally, heavy congestion on second roadway 504 may also create congestion on third roadway 506. However, the amount of congestion on third roadway 506 is likely to be less than the amount of congestion on fourth roadway 508 since third roadway 506 is further away from second roadway 504.

Next, during step 606, navigation system 100 may use the retrieved traffic information and the estimated congestion information to calculate a travel time along a selected route. Moreover, this method can be used to estimate travel times along various different routes for purposes of determining the fastest route as discussed earlier.

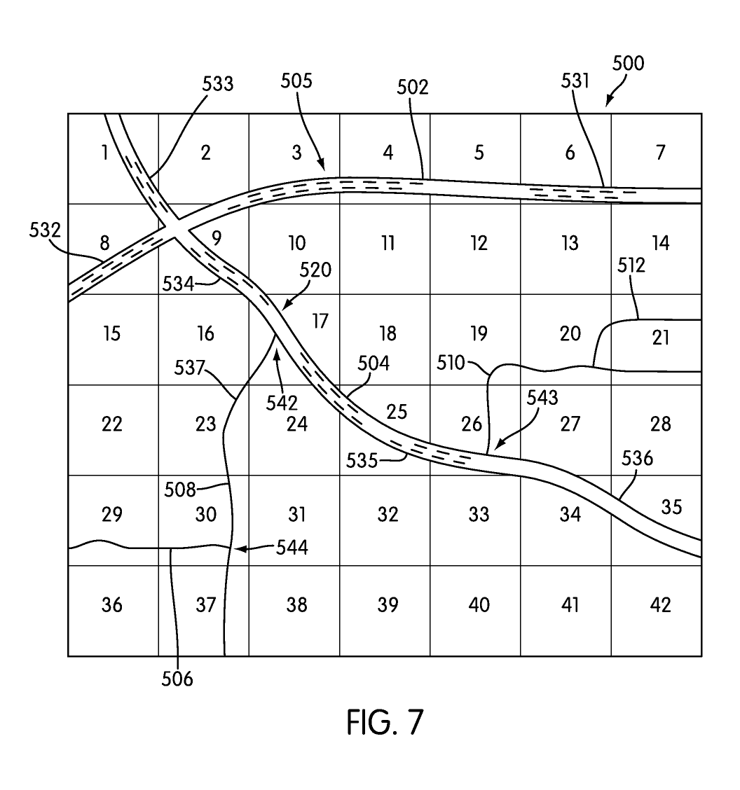

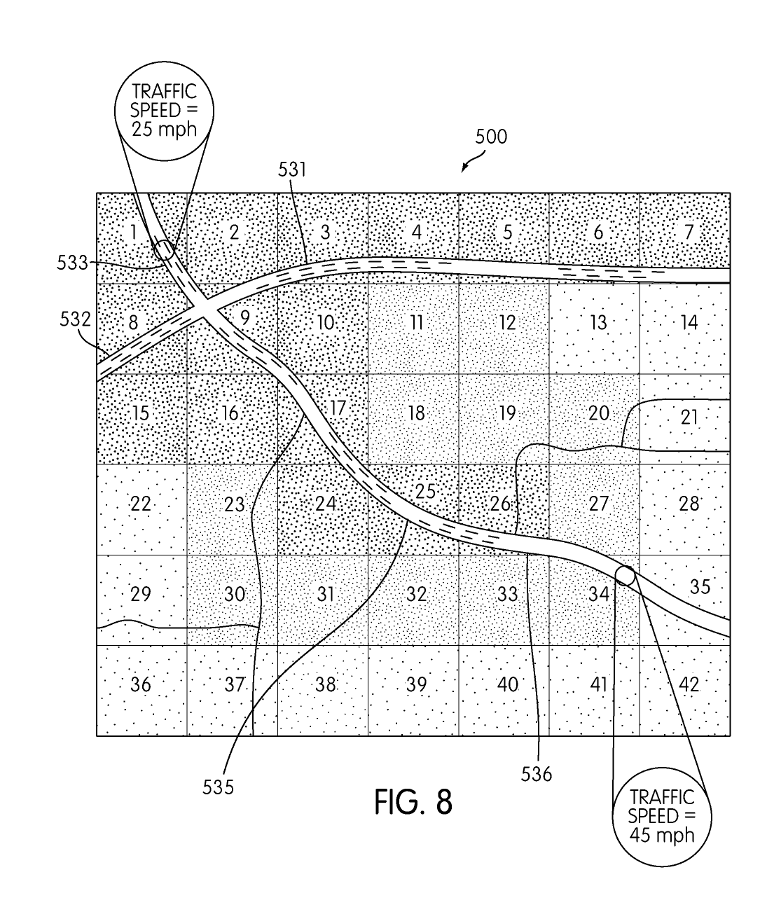

FIGS. 7 and 8 are intended to illustrate an embodiment of a method of estimating congestion information. Referring to FIG. 7, map portion 500 may be divided into a plurality of meshes 700. The term “mesh” as used throughout this detailed description and in the claims refers to a division of a map. In some cases, a mesh may be a rectangular division. In other cases, a mesh could be any other polygonal shape that may be used to divide a map into discrete regions. In the current embodiment, for example, plurality of meshes 700 may comprise rectangular regions of map portion 500. Together, plurality of meshes 700 may comprise a grid.

In some cases, each mesh of map portion 500 may be identified by a number. In the current embodiment, for example, each mesh is assigned an identification number from 1 to 42. For example mesh 1 is illustrated in the upper left-hand corner of map portion 500, while mesh 42 is illustrated in the lower right-hand corner of map portion 500. Although the current embodiment includes forty-two meshes, other embodiments could include any other number of meshes.

Each mesh may be associated with one or more roadway segments. For example, in the current embodiment, a portion of third roadway segment 533 is disposed in mesh 1. In addition, portions of first roadway segment 531 and fourth roadway segment 534 are disposed in mesh 9. It will be understood that a mesh could include any number of roadway segments.

In different embodiments, the size of the mesh, referred to as the “mesh size” could vary. In some cases, the size of the mesh may be determined according to computational constraints. In other cases, the size of the mesh could be determined according to the resolution of the navigation information used by a navigation system.

After dividing map portion 500 into a plurality of meshes, navigation system 100 may assign a congestion factor to each mesh that characterizes the average amount of congestion on roadway segments inside the mesh. Referring to FIG. 8, a congestion factor has been applied to each mesh within map portion 500. For purposes of illustration, the value of the congestion factor is indicated schematically by shading each mesh. Meshes with darker shading have larger congestion factors.

In this exemplary embodiment, congestion factors are generally largest in meshes associated with roadway segments having known congestion. For example, the average traffic speed on third roadway segment 533 is known to be about 25 miles per hour. Therefore, the congestion factor in mesh 1 is relatively large. However, in some cases, meshes with primary roadways 505 may not have large congestion factors. For example, in the current embodiment, the average traffic speed on sixth roadway segment 536 is known to be about 45 miles per hour. In other words, there is not much congestion on sixth roadway segment 536. Therefore, the congestion factors in mesh 27 and mesh 34 have moderate values.

Furthermore, the congestion factors for each mesh generally decreases according to the distance of the mesh from roadway segments with known congestion. For example, in this embodiment, the congestion factor in mesh 23 is lower than the congestion factor in mesh 24, since mesh 23 is disposed further from fifth roadway segment 535 than mesh 24. In a similar manner, the meshes with the lowest congestion factors are those meshes disposed furthest from roadway segments with known congestion. These meshes include, for example, mesh 22 and mesh 29 as well as mesh 41 and mesh 42.

Using this arrangement, a congestion factor can be applied to each mesh in map portion 500 according to the distance of each mesh from other meshes having known traffic congestion. Moreover, the congestion factor for a mesh can be applied to each roadway segment within the mesh when calculating the travel time on routes intersecting the mesh.

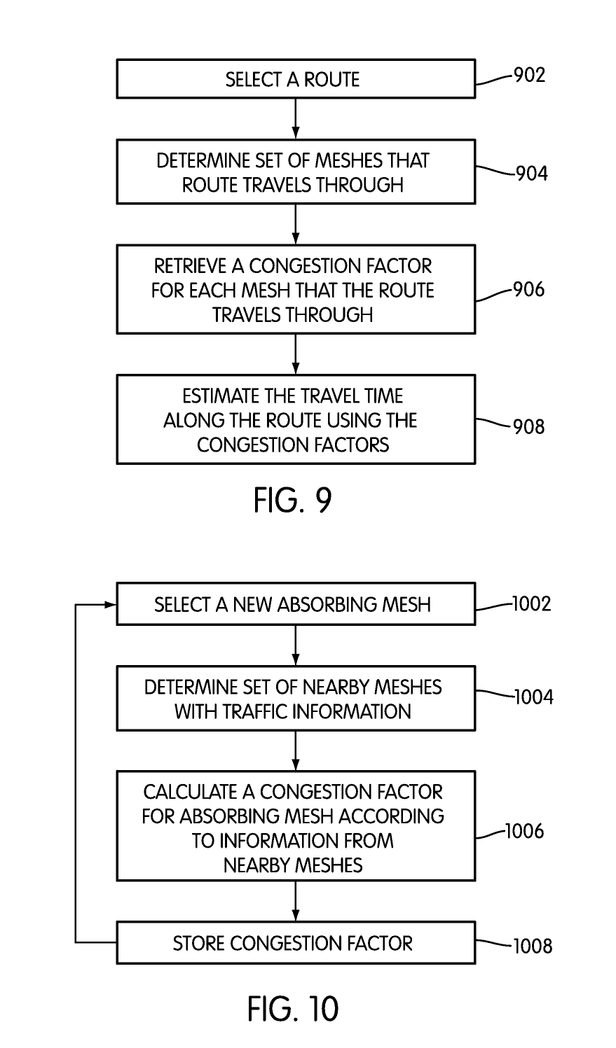

FIG. 9 illustrates an embodiment of a process of operating a navigation system. In some embodiments, some of the following steps could be accomplished by OBU 200. In other embodiments, some of the following steps could be accomplished by service provider 150. In addition, in other embodiments, some of the steps could be performed by other components of motor vehicle 102. For purposes of clarity, navigation system 100 may be used to refer collectively to OBU 200 and/or service provider 150. In other words, steps performed by navigation system 100 may be performed by either OBU 200 or service provider 150 in the following embodiments. It will be understood that in other embodiments one or more of the following steps may be optional.

During step 902, navigation system 100 may select a route. Next, during step 904, navigation system 100 may determine the set of meshes that the route travels through. Following step 904, during step 906, navigation system 100 may retrieve a congestion factor for each mesh that the route travels through. Next, during step 908, navigation system 100 may estimate the travel time along the route using the congestion factors. In one embodiment, the congestion factor may be used to estimate delays in travel times along various roadway segments. It will be understood that a congestion factor can be used in any way for purposes of approximating travel times on a route.

For purposes of understanding how a congestion factor may be determined in some embodiments, the term “absorbing mesh” is used throughout the detailed description and in the claims. An absorbing mesh includes roadways that may be affected by the congestion of nearby roadways with known traffic information. In some cases, an absorbing mesh may include roadways with known traffic information. In other cases, an absorbing mesh may not include any roadways with known traffic information. In an exemplary embodiment, the congestion levels on roadways within an absorbing mesh may be affected by congestion on roadways in multiple different meshes.

FIG. 10 illustrates an embodiment of a detailed process for determining a congestion factor for each mesh associated with a map portion. During step 1002, navigation system 100 may select a new absorbing mesh. The absorbing mesh may be selected from any set of meshes corresponding to a map portion. Next, during step 1004, navigation system 100 may determine a set of nearby meshes with traffic information. In some cases, this set may include meshes that are within a predetermined maximum distance from the absorbing mesh. Next, during step 1006, navigation system 100 may calculate a congestion factor for the selected absorbing mesh according to the traffic information from the nearby meshes. In some cases, the distance from each of the nearby meshes can also be used in calculating the congestion factor.

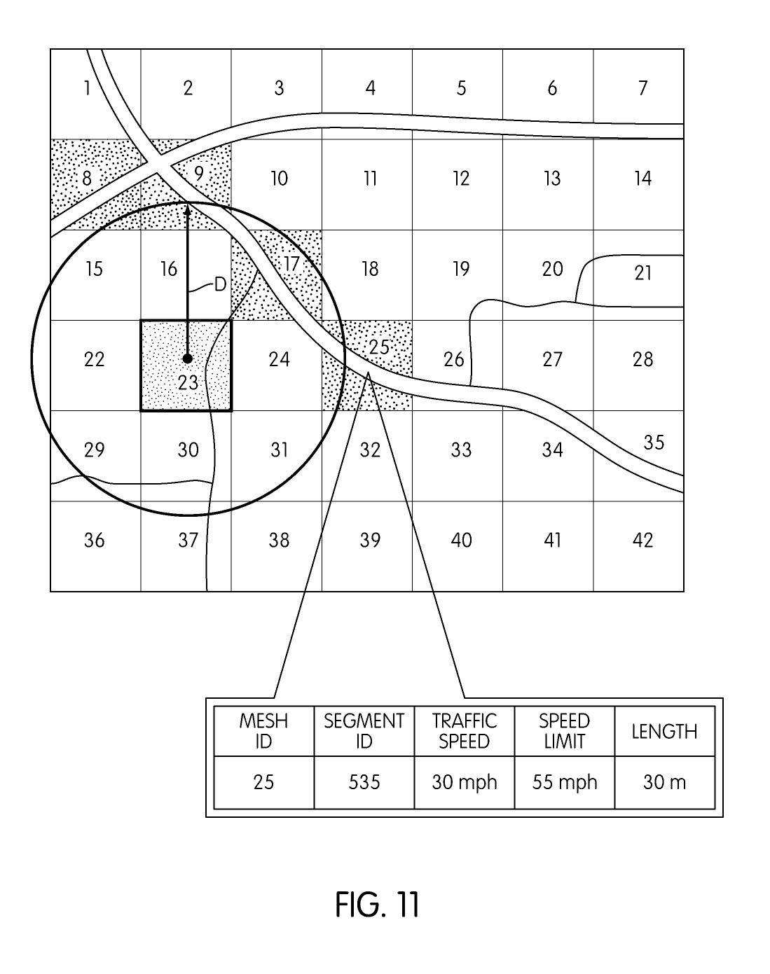

FIG. 11 illustrates an exemplary embodiment of a method of calculating a congestion factor for an absorbing mesh. In this example, navigation system 100 may calculate a congestion factor for mesh 23, which is an absorbing mesh. In order to calculate a congestion factor, navigation system 100 may retrieve a predetermined spread distance D. The spread distance D is the maximum distance that a traffic effect will spread. In other words, meshes separated by a distance greater than the spread distance D are assumed not to influence one another. The value of the spread distance D can vary in different embodiments. In some cases, spread distance D can be given in terms that are relative to the selected mesh size. For example, in one embodiment, spread distance D may be 2 mesh widths. In other cases, spread distance D can be given in terms of an absolute distance. For example, in some cases, spread distance D could have a value in the range between 0 and 100 miles. In other cases, spread distance D could have any other value.

Once the spread distance D has been selected, navigation system 100 may determine a set of meshes that are within the spread distance D from mesh 23 and that also include roadways segments with traffic information. In this case, mesh 8, mesh 9, mesh 17 and mesh 25 are all within spread distance D from mesh 23. In addition, mesh 8, mesh 9, mesh 17 and mesh 25 all include roadways segments with traffic information. For example, in this case, mesh 25 includes fifth roadway segment 535 that includes traffic information. In particular, fifth roadway segment 535 has an average traffic speed of 30 miles per hour and a speed limit of 55 miles per hour. In a similar manner, traffic information may be available for roadway segments in each of mesh 8, mesh 9 and mesh 17. Using this traffic information, as well as the distances of each of mesh 8, mesh 9, mesh 17 and mesh 25 from mesh 23, a congestion factor for mesh 23 can be calculated.

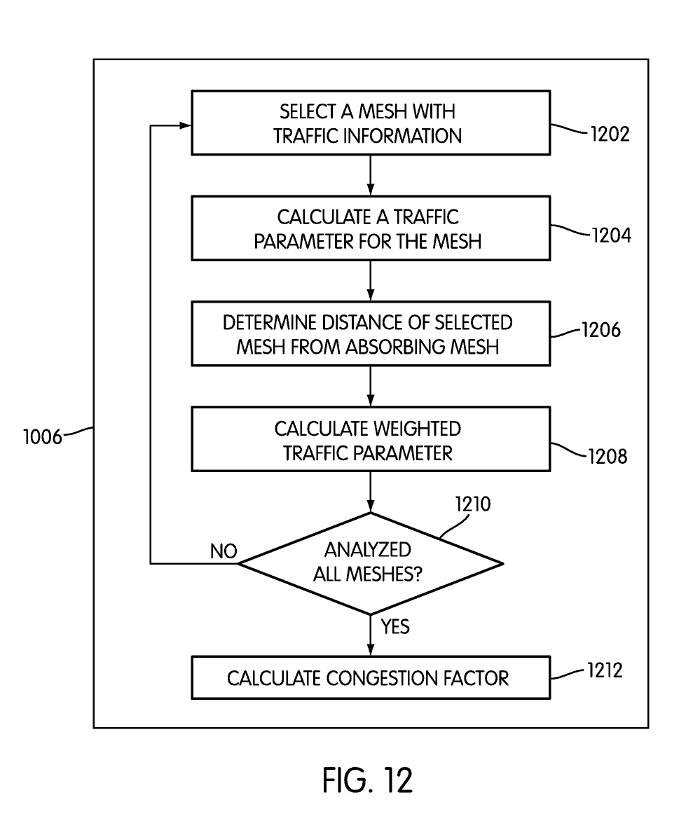

Generally, any mathematical formula and/or algorithm can be used for calculating a congestion factor for each absorbing mesh. FIG. 12 is intended to illustrate an embodiment one possible algorithm for calculating a congestion factor. During step 1202, navigation system 100 may select a mesh with traffic information. In particular, the mesh may be a mesh selected from the set of nearby meshes with traffic information as previously discussed. Next, during step 1204, navigation system 100 may calculate a traffic parameter for the mesh. The traffic parameter can be any parameter that characterizes the average traffic levels on roadway segments with the selected mesh. For example, in some cases, the average traffic parameter can be calculated using the average dynamic vehicle speed and the average static traffic speed for each roadway segment in the mesh having traffic information. Following step 1204, during step 1206, navigation system 100 may determine the distance from the selected mesh to the absorbing mesh. Next, during step 1208, navigation system 100 may calculate a weighted traffic parameter. In some cases, the weighted traffic parameter may be equal to the traffic parameter divided by the square of the distance between the selected mesh and the absorbing mesh.

Next, during step 1210, navigation system 100 may determine if each of the meshes in the set of nearby meshes has been analyzed. If not, navigation system 100 may proceed back to step 1202 to select a new mesh. Otherwise, if each mesh in the set of nearby meshes has been analyzed, navigation system 100 may proceed to step 1212 to calculate the congestion factor for the absorbing mesh. In some embodiments, the congestion factor may be proportional to the sum of the weighted traffic parameter from each mesh in the set of nearby meshes.

In some embodiments, this method may be used for calculating a congestion factor for each absorbing mesh in a map portion. In some cases, each mesh in the map portion may be an absorbing mesh. In other cases, only some meshes may be absorbing meshes. Furthermore, it will be understood, that the method shown in FIG. 12 for calculating a congestion factor is only intended to be exemplary. In other embodiments, any other methods, algorithms and/or formula could be used.

While various embodiments of the invention have been described, the description is intended to be exemplary, rather than limiting and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

What is claimed is:

1. A method of providing navigation information for a motor vehicle, comprising the steps of:
retrieving navigation information;
selecting a first roadway segment and a second roadway segment from the navigation information, the second roadway segment being within a predetermined distance from the first roadway segment;
retrieving traffic information corresponding to the second roadway segment;
calculating a congestion factor for the first roadway segment using the traffic information corresponding to the second roadway segment; and
using the congestion factor to estimate a travel time for a route, the route including the first roadway segment.

2. The method according to claim 1, wherein the first roadway segment is associated with a surface street.

3. The method according to claim 1, wherein the second roadway segment is associated with a highway.

4. The method according to claim 1, wherein the traffic information includes average traffic speed on the second roadway segment.

5. The method according to claim 1, wherein the congestion factor varies as a function of the distance between the first roadway segment and the second roadway segment.

6. The method according to claim 1, wherein the congestion factor is associated with a delay in the normal travel time on the first roadway segment.

7. A method of providing navigation information for a motor vehicle, comprising the steps of:
retrieving navigation information corresponding to a portion of a map;
dividing the portion of the map into a plurality of meshes;
selecting an absorbing mesh from the plurality of meshes;
retrieving a predetermined distance;
selecting a set of meshes, the set of meshes being within the predetermined distance from the absorbing mesh and wherein each mesh in the set of meshes includes at least one roadway segment with traffic information;
calculating a congestion factor for the absorbing mesh using traffic information from each mesh in the set of meshes; and
using the congestion factor to calculate a travel time for a route, the route including a roadway segment in the first mesh.

8. The method according to claim 7, wherein a traffic parameter is calculated for each mesh in the set of meshes.

9. The method according to claim 8, wherein the traffic parameter is calculated using the traffic information.

10. The method according to claim 8, wherein a weighted traffic parameter is calculated by dividing the traffic parameter for each mesh by the square of the distance between the mesh and the absorbing mesh.

11. The method according to claim 10, wherein the congestion factor is proportional to the sum of the weighted traffic parameters for each mesh.

12. The method according to claim 7, wherein the congestion factor is associated with each roadway segment in the absorbing mesh.

13. The method according to claim 7, wherein the congestion factor is associated with a delay time on each roadway segment.

14. A method of providing navigation information for a motor vehicle, comprising the steps of:
retrieving navigation information corresponding to a plurality of roadway segments;
retrieving traffic information for a first set of roadways;
selecting a second set of roadways;
estimating congestion information for the second set of roadways using the traffic information; and
using the estimated congestion information to calculate the travel time along a route.

15. The method according to claim 14, wherein the first set of roadways includes highways.

16. The method according to claim 15, wherein the second set of roadways includes surface streets.

17. The method according to claim 14, wherein the step of estimating congestion information includes a step of determining the distances between each of the roadways in the first set of roadways and each of the roadways in the second set of roadways.

18. The method according to claim 14, wherein the traffic information is received from a traffic database.

19. The method according to claim 14, wherein the traffic information is real time traffic information.

20. The method according to claim 14, wherein the traffic information is historical traffic information.
